(19) United States
(12) Patent Application Publication
(10) Pub. No.: US 2002/0161983 A1
(43) Pub. Date: Oct. 31, 2002

(54) System, method, and computer program product for shared device of storage compacting

(75) Inventors: Don Milos, Red Hook, NY (US); John W. Bates, Mendon, MA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: StorageApps Inc.

(21) Appl. No.: 09/788,658

(22) Filed: Feb. 21, 2001

(51) Int. Cl. G06F 12/00

(52) U.S. Cl. 711/202

(57) ABSTRACT

A virtual storage system, method and computer program product for providing efficient use of storage resources. The system includes a plurality of host systems, an appliance coupled to each of the host systems and at least one physical storage device coupled to the appliance. The appliance manages the allocation of storage space on the physical storage device to the host systems. The appliance allocates virtual storage space to the host systems. The cumulative amount of virtual storage space allocated to the host systems exceeds the actual storage capacity of the physical storage device. The appliance allocates physical space on the physical storage device on an as needed basis.

### CROSS-REFERENCE TO RELATED APPLICATIONS

“Method, System, and Computer Program Product for a Data Propagation Platform and Applications of Same,” Ser. No. 09/665,583, filed on Sep. 18, 2000.

### STATEMENT REGARDING FEDERALLY-SPONSORED RESEARCH AND DEVELOPMENT

Not applicable.

### REFERENCE TO MICROFICHE APPENDIX/SEQUENCE

Not applicable.

### BACKGROUND OF THE INVENTION

1. Field of the Invention

The invention relates generally to the field of data storage, and more particularly to a virtual storage system, method and computer program product that achieves efficient use of limited storage resources.

2. Background Art

Traditional “virtual storage” involves combining discrete storage devices of relatively small storage capacity into a virtual storage pool of much larger capacity as viewed from a host. For instance, a pool of storage containing 100 Gigabytes (GB) of storage as seen by the host may in reality be made up of ten (10) different 10 GB devices. This type of virtual storage allows a storage controller to spread data from each host across each of the ten different 10 GB storage devices.

While this arrangement is often called storage virtualization, this is not true storage virtualization, since actual physical storage capacity backs up the virtual pool. That is, the virtual capacity of a virtual pool is supported by real physical storage (albeit not in one single device). At any given time, the vast amount of storage comprising the virtual pool sits unused.

Thus, in traditional storage virtualization, the amount of storage that a host believes is available, actually is available. The drawback of traditional virtual storage is that the system actually needs physical storage backing up the virtual storage pool. Traditional storage virtualization may use several different storage devices to construct a virtual storage pool. Specific amounts of physical storage are assigned to each host. This type of storage virtualization does not promote optimal storage and device efficiency because the vast majority of storage in the virtual storage pool is not used at any given time.

What is therefore needed is a system, method and computer program product for providing true storage virtualization where the virtual storage capacity is not entirely supported by real physical storage. What is further needed is a system, method and computer program product for providing true storage virtualization that uses a storage device or a network of storage devices that serve a plurality of hosts by providing each host with only that amount of physical storage necessary to carry out the input/output (I/O) storage operations for that host. Still further, what is needed is a system, method and computer program product that eliminates the need for having a system administrator assign specific amounts of physical storage to each host ahead of time.

### SUMMARY OF THE INVENTION

The present invention is a virtual storage system, method and computer program product for providing efficient use of storage resources. The system includes a plurality of host systems, an appliance coupled to each of the host systems and at least one physical storage device coupled to the appliance. The appliance manages the allocation of storage space on the physical storage device to the host systems. The appliance allocates virtual storage space to the host systems. The cumulative amount of virtual storage space allocated to the host systems exceeds the actual storage capacity of the physical storage device. The appliance allocates physical space on the physical storage device on an as needed basis.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a simplified block diagram of an exemplary embodiment of the present invention.

FIG. 2 is a block diagram illustrating the “virtual” functionality of a SAN appliance according to an embodiment of the present invention.

FIG. 3 is a block diagram illustrating another exemplary embodiment of the present invention.

FIG. 4 is a flow diagram for transforming a LUN into a share device module.

FIG. 5 is a block diagram representing an implementation of a DPF share device module.

FIG. 6 is an exemplary diagram of the components of a share device.

FIG. 7 is a block diagram illustrating mapping block levels according to an embodiment of the present invention.

FIG. 8 illustrates an example data communications network in which the present invention may be implemented.

FIG. 9A is a flow diagram for a write operation according to an embodiment of the present invention.

FIG. 9B is a flow diagram for a read operation according to an embodiment of the present invention.

FIG. 10 illustrates an example computer system for implementing the present invention.

The features and advantages of the present invention will become more apparent from the detailed description set forth below when taken in conjunction with the drawings in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which the present invention would be of significant utility.

Terminology

To more clearly delineate the present invention, an effort is made throughout the specification to adhere to the following term definitions as consistently as possible.

Arbitrated Loop A shared 100 MBps Fibre Channel transport supporting up to 126 devices and 1 fabric attachment.

Backing Store A non-volatile memory. The term backing store is often used to contrast with cache, which is usually a volatile random access memory used to speed up I/O operations. Data held in a volatile cache must be replicated in or saved to a non-volatile backing store so that it can survive a system crash or power failure.

Fabric One or more Fibre Channel switches in a networked topology.

GBIC Gigabit interface converter; a removable transceiver module for Fibre Channel and Gigabit Ethernet physical-layer transport.

GLM Gigabit link module; a semipermanent transceiver that incorporates serializing/deserializing functions.

HBA Host bus adapter; an interface between a server or workstation bus and a Fibre Channel network.

Hub In Fibre Channel, a wiring concentrator that collapses a loop topology into a physical star topology.

Initiator On a Fibre Channel network, typically a server or a workstation that initiates transactions to disk or tape targets.

JBOD Just a bunch of disks; typically configured as an Arbitrated Loop segment in a single chassis.

LAN Local area network; a network linking multiple devices in a single geographical location.

Logical Unit An entity within a target that executes I/O commands. For example, SCSI I/O commands are sent to a target and executed by a logical unit within that target. A SCSI physical disk typically has a single logical unit. Tape drives and array controllers may incorporate multiple logical units to which I/O commands can be addressed. Typically, each logical unit exported by an array controller corresponds to a virtual disk.

LUN Logical Unit Number. The identifier of a logical unit within a target, such as a SCSI identifier.

Point-to-point A dedicated Fibre Channel connection between two devices.

Private loop A free-standing Arbitrated Loop with no fabric attachment.

Private loop device An Arbitrated Loop device that does not support fabric login.

Public loop An Arbitrated Loop attached to a fabric switch.

Public loop device An Arbitrated Loop device that supports fabric login and services.

RAID Redundant Array of Independent Disks.

SCSI Small Computer Systems Interface; both a protocol for transmitting large blocks of data and a parallel bus architecture.

SCSI-3 A SCSI standard that defines transmission of SCSI protocol over serial links.

Storage Any device used to store data; typically, magnetic disk media or tape.

Switch A device providing full bandwidth per port and high-speed routing of data via link-level addressing.

Target Typically a disk array or a tape Subsystem on a Fibre Channel network.

Topology The physical or logical arrangement of devices in a networked configuration.

Virtual Disk A set of disk blocks presented to an operating environment as a range of consecutively numbered logical blocks with disk-like storage and I/O semantics.

WAN Wide area network; a network linking geographically remote sites.

Overview

The present invention is directed to a virtual storage system, method, and computer program product that achieves efficient use of storage resources. According to the present invention, a share device is used to create and manage virtual disk devices for host systems. The virtual disk devices resemble physical disk devices from a host system's viewpoint, but in reality are a set of disk blocks presented as a range of consecutively numbered logical blocks. The host computers utilize the virtual disk devices in the same manner as a physical disk device. The virtual disk devices are referred to as share targets. The share device couples to a physical storage device and is a gateway to the physical storage device. The physical storage device serves as a backing store for the share targets. The share device is unique from other virtual device implementations in that no physical space is allocated to the virtual device up front. Instead, space is allocated as blocks on the share target device are written. Allocating physical space as needed allows system administrators to create large virtual devices starting with relatively small amounts of backing store (i.e., physical space). As demand increases, the backing store can be increased dynamically without affecting the virtual devices that are visible to the host systems.

Thus, in one embodiment, in which a particular host computer believes that a certain amount of storage has been exclusively dedicated to that host computer, in reality, the physical storage device to which the host computer is connected may be oversubscribed in that the cumulative amount of storage “promised” to all of the host computers connected to that storage device far exceeds the actual storage capacity of the physical storage device. For example, five (5) host computers are all connected to a 10 Gigabyte storage device. Each of the five host computers are promised 10 Gigabytes of storage. Although the physical storage device is oversubscribed by 5 times its true capacity, the five host computers will not all require 10 Gigabytes of storage at the same time. Instead, each host computer will need only a small portion of that storage at any given time. Thus, physical storage need not be allocated to a host computer until it is actually needed. Only when a host computer needs to write to storage is physical storage dedicated to that host computer.

In another embodiment of the present invention, no physical storage device is actually dedicated to a particular host computer. Rather, the host computer is coupled to the physical storage via an appliance. The host computer is coupled directly to a share device target within the appliance, which is in turn coupled to a share device within the appliance, which is then coupled to the physical storage. The appliance informs the particular host computer that a specific amount of storage (i.e., virtual storage) is available, but in reality, no such physical storage is actually assigned to that particular host computer. Whenever that particular host computer wants to write to storage, such physical storage is allocated by the appliance as needed. Typically, the total amount of physical storage dedicated to the host computer is far below that which is virtually allocated to that host computer.

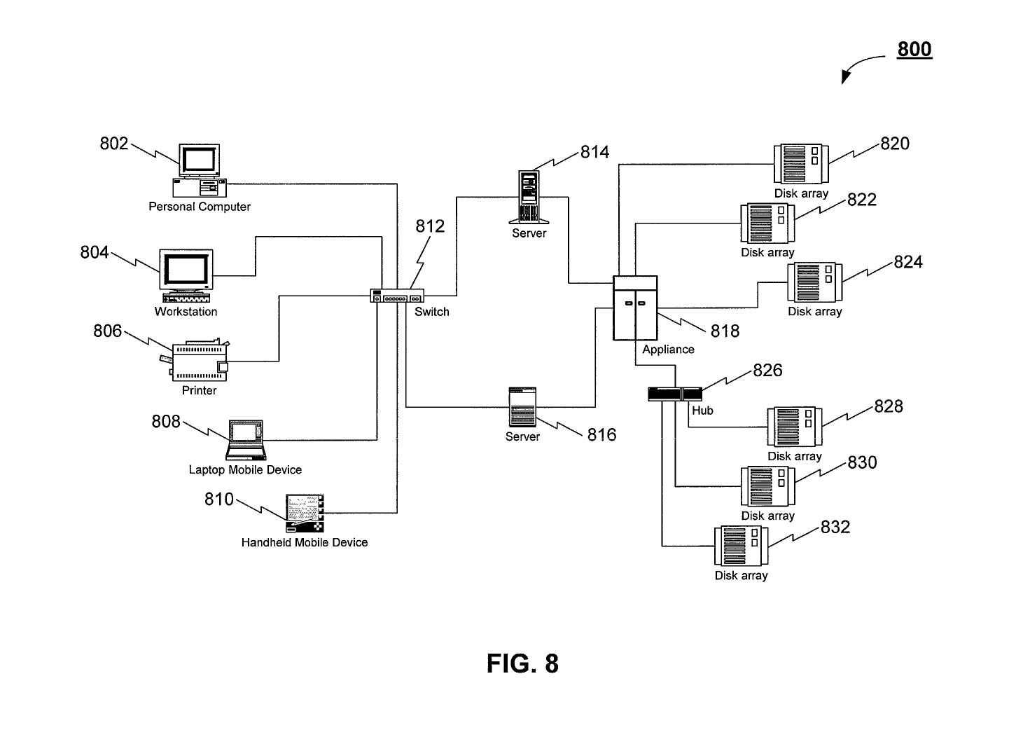

Prior to describing the present invention in detail, an exemplary environment in which the present invention may operate is described. FIG. 8 illustrates an example data communication network 800. Network 800 includes a variety of devices which support communication between many different entities, such as, but not limited to, businesses, universities, individuals, government, and financial institutions. As shown in FIG. 8, a communication network, or combination of networks, interconnects the elements of network 800.

Network 800 supports many different types of communication links implemented in a variety of architectures.

Network 800 may be considered to be an example of a storage area network (SAN) that is applicable to the present invention. Network 800 comprises a pool of storage devices, including disk arrays 820, 822, 824, 828, 830, and 832. Network 800 provides access to this pool of storage devices to hosts/servers comprised by or coupled to network 800. Network 800 may be configured, for example, as point-to-point, arbitrated loop, or fabric topologies, or combinations thereof.

Network 800 comprises a switch 812. Switches, such as switch 812, typically filter and forward packets between local area network (LAN) segments, as well as other networks, such as, for example, the World Wide Web. Switch 812 may be an Ethernet switch, fast-Ethernet switch, or another type of switching device known to persons skilled in the relevant art(s). In other examples, switch 812 may be replaced by a router or a hub. A router generally moves data from one local segment to another, and to a telecommunications carrier, such as AT&T or WorldCom, for remote sites. A hub is a common connection point for devices in a network. Suitable hubs include passive hubs, intelligent hubs, switching hubs, and other types of hubs known to persons skilled in the relevant art(s).

Various types of terminal equipment and devices may interface with network 800. For example, a personal computer 802, a workstation 804, a printer 806, a laptop mobile device 808, and a handheld mobile device 810 interface with network 800 via switch 812. Further types of terminal equipment and devices that may interface with network 800 may include local area network (LAN) connections (e.g., other switches, routers, or hubs), personal computers with modems, content servers of multi-media, audio, video, and other information, pocket organizers, Personal Data Assistants (PDAs), cellular phones, Wireless Application Protocol (WAP) phones, and set-top boxes. These and additional types of terminal equipment and devices, and ways to interface them with network 800, will be known by persons skilled in the relevant art(s) from the teachings herein.

Network 800 includes one or more hosts or servers. For example, network 800 comprises server 814 and server 816. Servers 814 and 816 provide devices 802, 804, 806, 808, and 810 with network resources via switch 812. Servers 814 and 816 are typically computer systems that process end-user requests for data and/or applications. In one example configuration, servers 814 and 816 provide redundant services. In another example configuration, servers 814 and 816 provide different services and thus share the processing load needed to serve the requirements of devices 802, 804, 806, 808, and 810. In further example configurations, one or both of servers 814 and 816 are connected to the Internet, and thus server 814 and/or server 816 may provide Internet access to network 800. One or both of servers 814 and 816 may be Windows NT servers or UNIX servers, or other servers known to persons skilled in the relevant art(s).

A SAN appliance is included in network 800 according to embodiments of the present invention. For example, a SAN appliance 818 may be implemented to provide the required connectivity between the storage device network (disk arrays 820, 822, 824,828, 830, and 832) and hosts and servers 814 and 816. One such SAN appliance is a SANLink™ appliance, developed by StorageApps Inc., located in Bridgewater, N.J. SAN appliance 818 is a computer that operates to manage the storage devices (disk arrays 820, 822, 824, 828, 830, and 832) of the storage device network for hosts and servers 814 and 816. For example, if a host or server 814 seeks to access a storage device for I/O operations, SAN appliance 818 determines which storage devices on the storage network (disk arrays 820, 822, 824, 828, 830, and 832) host or server 814 can access. As described herein, SAN appliance 818 also provides the virtual storage functionality of the present invention.

Network 800 includes a hub 826. Hub 826 is connected to disk arrays 828, 830, and 832. Preferably, hub 826 is a fibre channel hub or other device used to allow access to data stored on connected storage devices, such as disk arrays 828, 830, and 832. Further fibre channel hubs may be cascaded with hub 826 to allow for expansion of the SAN, with additional storage devices, servers, hosts, and other devices. In an example configuration for network 800, hub 826 is an arbitrated loop hub. In such an example, disk arrays 828, 830, and 832 are organized in a ring or loop topology, which is collapsed into a physical star configuration by hub 826. Hub 826 allows the loop to circumvent a disabled or disconnected device while maintaining operation.

Network 800 may include one or more switches, such as switch 812, that allow devices 802-810 to access servers 814 and/or 816, thus allowing access to data arrays 820-832.

Disk arrays 820, 822, 824, 828, 830, and 832 are storage devices providing data and application resources to servers and hosts 814 and 816 through appliance 818 and hub 826. As shown in FIG. 8, the storage of network 800 is principally accessed by hosts and servers 814 and 816 through appliance 818.

The storage devices may be fibre channel-ready devices, or SCSI (Small Computer Systems Interface) compatible devices, for example. Fibre channel-to-SCSI bridges may be used to allow SCSI devices to interface with fibre channel hubs and switches, and other fibre channel-ready devices. One or more of disk arrays 820, 822, 824, 828, 830, and 832 may instead be alternative types of storage devices, including tape systems, JBODs (Just a Bunch of Disks), floppy disk drives, optical disk drives, and other related storage drive types.

The topology or architecture of network 800 will depend on the requirements of the particular application, and on advantages offered by the chosen topology. One or more hubs 826, one or more switches, and/or one or more appliances 818 may be interconnected in any number of combinations to increase network capacity. Disk arrays 820, 822, 824, 828, 830, and 832, or fewer or more disk arrays as required, may be coupled to network 800 via these hubs 826, switches, and appliances 818.

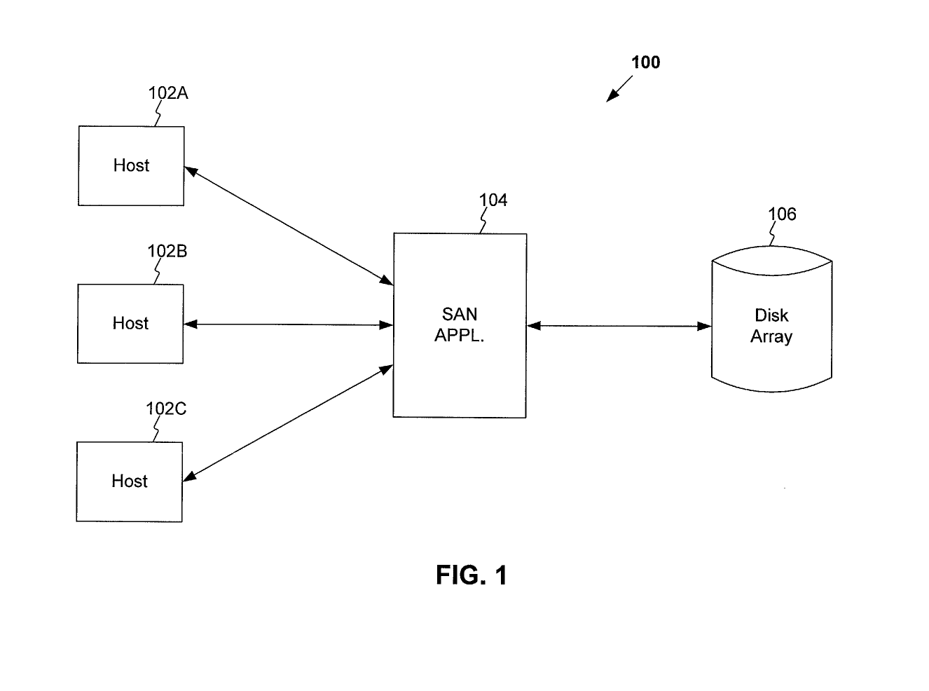

FIG. 1 is a simplified block diagram 100 of an exemplary embodiment of the present invention. Block diagram 100 comprises a plurality of host computers 102A-C, a SAN appliance 104 and a disk array 106. SAN appliance 104 is coupled to host computers 102A-C on one side and to disk array 106 on the other side. Host computers 102A-C may include, but are not limited to, mainframes, servers, workstations, personal computers, multiprocessors and clustered computer complexes. Although FIG. 1 shows three host computers, one skilled in art would know that more or less host computers could be implemented without departing from the scope of this invention. SAN appliance 104 includes a computer. SAN appliance 104 is interfaced between host computers 102A-C and disk array 106 to manage storage allocation of disk array 106 for host computers 102A-C. SAN appliance 104 provides virtual storage to host computers 102A-C. Each of the host computers 102A-C believes that it has access to a specific amount of physical storage dedicated to it on SAN appliance 104. However, specific storage is not physically dedicated to any of host computers 102A-C. Instead, each host computer 102A-C is assigned real physical storage only when it actually needs it.

According to the present invention, SAN appliance 104 implements virtual storage using “share devices” and “share targets.” In an embodiment, the share devices and share targets are software modules. The share device is coupled to a physical storage device and, is a gateway to the physical storage device. The share targets are virtual disk devices created and managed by the share device. The share targets are visible to host computers 102A-C. When an input/output (I/O) operation from one of hosts 102A-C requires data to be written into storage, physical storage is allocated to the share target on SAN appliance 104 to hosts 102A-C. The share device receives the data from the share target, maps the virtual disk blocks to physical disk blocks, allocates physical storage space on the physical storage device, and writes the data onto the physical storage device. The physical storage device serves as the backing store for the share targets. In reality, disk array 106 is the storage device that provides data and application resources to hosts 102A-C through SAN appliance 104. Each share target associated with a shared device is assigned its own unique logical unit number (LUN). Host computers 102A-C can address a logical unit, such as a physical or virtual device, by its LUN. The LUN tells SAN appliance 104 which virtual device (e.g, share target) is being addressed.

In an alternative embodiment, each share device and its associated share targets could be implemented as a single share device module. In this embodiment, the share device module would provide the functionality of both the share device and the share targets.

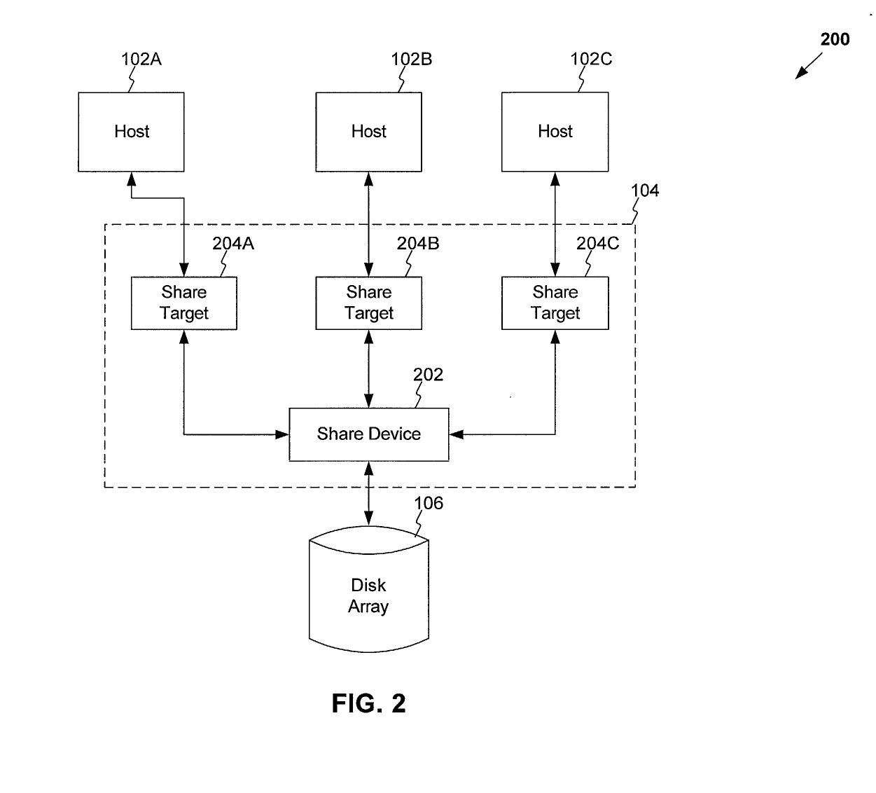

FIG. 2 is a block diagram 200 illustrating the “virtual” components of SAN appliance 104 according to an embodiment of the present invention. SAN appliance 104 comprises a share device 202 and three share targets 204A-C. In an embodiment of the present invention, share device 202 and share targets 204A-C are implemented in software. Disk array 106 lies beneath, and is coupled to, share device 202. Share targets 204A-C lie above, and are coupled separately to, share device 202. Host computer 102A is coupled to share target 204A. Host computer 102B is coupled to share target 204B. Host computer 102C is coupled to share target 204C. A single share device, such as share device 202, may create one or more share targets, such as share targets 204A-C, as shown in FIG. 2. Each share target is given a unique LUN. Share device 202 is not visible to host computers 102A-C. Share targets 204A-C are the virtual disk devices that are visible to host computers 102A-C, respectively. Share device 202 is coupled to disk array 106 which serves as the backing store for share targets 204A-C. In one embodiment, physical storage space is allocated to host computers 102A-C on a first come, first serve basis. Alternatively, physical storage space may be allocated according to a priority rating given to the host computers. Other allocation algorithms can be employed without departing from the scope of the invention.

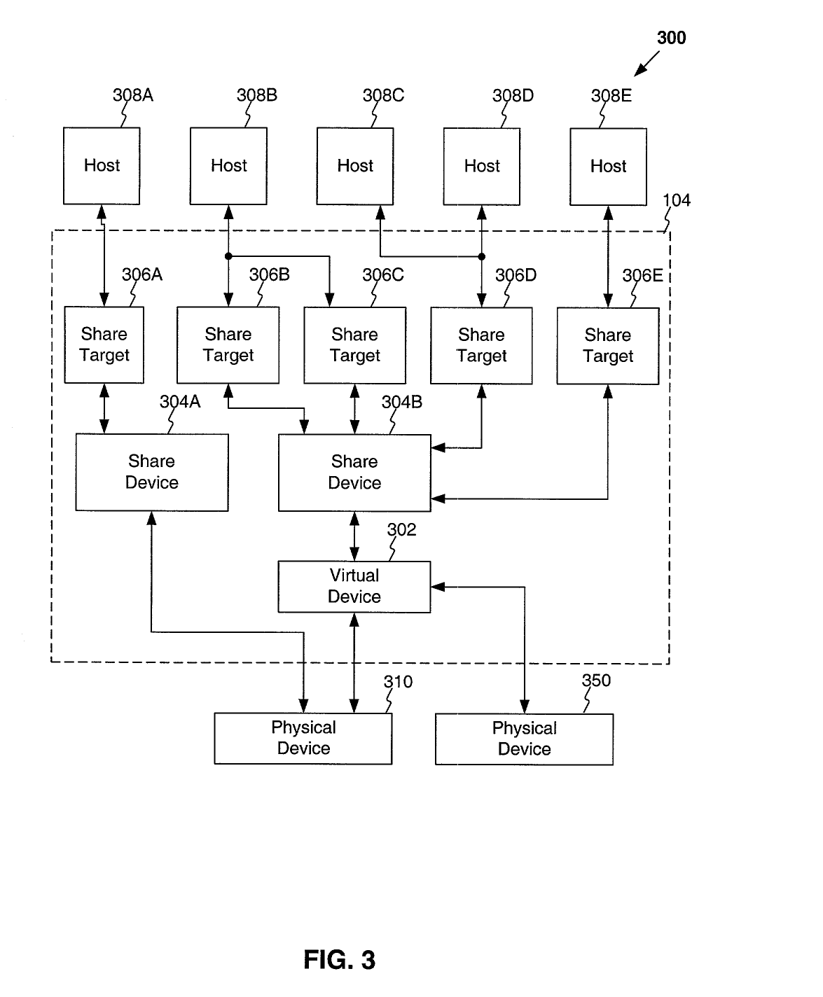

FIG. 3 is a block diagram 300 illustrating another exemplary embodiment of the present invention. Diagram 300 illustrates the concept of multiple hosts sharing a single share target and a single host utilizing multiple share targets in a single SAN appliance. Diagram 300 comprises host computers 308A-E, SAN appliance 104, and a physical storage device 310. Storage device 310 lies beneath SAN appliance 104 and is coupled to SAN appliance 104. Host computers 308A-E lie above SAN appliance 104 and are coupled to SAN appliance 104. SAN appliance 104 is comprised of a virtual storage device 302, two share devices 304A and 304B, and five (5) share targets 306A-E. Again, share devices 304A and 304B are not visible to host computers 308A-E. Host computers 308A-E interface directly to share targets 306A-E.

In this example, host computer 308A is coupled to share target 306A. Share device 304A is coupled to share target 306A which is coupled to physical storage device 310. Physical storage device 310 serves as a backing store for share target 304A. Host computer 308B is coupled to share targets 306B and 306C. Share device 304B is coupled to share targets 306B and 306C. Host computers 308C and 308D are coupled to share target 306D. Share device 304B is coupled to share targets 306C and 306D. Host computer 308E is coupled to share target 306E. Share device 304B is also coupled to share target 306E. Virtual device 302 is coupled to share device 304B, and physical storage device 310 is coupled to virtual device 302. Physical storage device 310 serves as the backing store for share targets 306B, 306C, 306D, and 306E.

As shown in FIG. 3, both share devices 304A and 304B use physical storage device 310 as the backing store for share targets 306A-E. In an embodiment of the present invention, multiple share devices, such as share devices 304A and 304B normally cannot share the same physical storage space. To overcome this problem of shared physical storage space, physical storage device 310 is partitioned to create a subdivision of physical storage device 310. Alternatively, share devices 304A and 304B may be coupled to separate physical storage devices. In yet another alternative embodiment, share devices 304A and 304B may be coupled to a storage array network, as described above with respect to FIG. 8. In this embodiment, SAN appliance 104 could allocate storage space for share devices 304A and 304B on separate storage disks, respectively.

As previously stated, share device 304B also couples to virtual storage device 302. Virtual storage device 302 may be used to provide mirroring in which an image of data is replicated across two physical disks, such as physical devices 310 and 350, snapshots in which a frozen image of a disk is preserved, partitioning of a physical disk device into a virtual disk, and/or expansion in which two physical logical units or disks are merged into a single virtual device. The concepts of mirroring, snapshots, partitioning, and expansion are further described in a co-pending application entitled “Method, System, and Computer Program Product for a Data Propagation Platform and Applications of Same,” Ser. No. 09/665,583, filed on Sep. 18, 2000, which is incorporated by reference herein in its entirety.

In FIG. 3, hosts 308C and 308D both couple to share target 306D. This enables the sharing of all the data in share target 306D by both hosts (308C and 308D). Also shown in FIG. 3 is host 308B utilizing multiple share targets (share targets 306B and 306C). In this scenario, host 308B may have multiple file systems and/or multiple data sets. By utilizing two share targets, host 308B may store particular file systems and/or data sets on one share target (306B or 306C) and the remaining file system(s) and/or data set(s) on the other share target (306B or 306C).

FIG. 3 also shows more than one share device (304A and 304B) implementation in a single SAN appliance (104). The implementation of multiple share devices on a single SAN appliance has administrative advantages. An administrator has the ability to prioritize hosts connected to a particular share device. For example, if the operations of host 308A are mission critical, then having host 308A solely coupled to share device 304A will provide a lower risk running out of physical disk space and/or data corruption than having host 308A coupled to share device 304B along with four other hosts (308B, 308C, 308D, and 308E). In an extreme mission critical situation, share device 304A would be coupled to a separate physical storage device other than storage device 310. A method for implementing share devices on a SAN appliance will now be discussed.

Implementation of a Share Device

In one embodiment, share devices are implemented by creating a chain of device modules that form data paths. This technique, known as data propagation framework (DPF), provides an object oriented framework for the construction of applications, such as, but not limited to, storage applications. Device modules within a DPF can be linked and re-linked to form different data paths. Device modules are objects or run-time entities constructed to perform operations on the data flowing through them in the data path. Data and commands from devices in the virtual storage system are entered into the device chain and are passed along from device module to device module. The device modules within the chain of devices manipulate passing objects by processing only those objects that they are designed to understand. DPFs are disclosed in more detail in the co-pending application entitled “Method, System, and Computer Program Product for a Data Propagation Platform and Applications of Same,” Ser. No. 09/665,583, filed on Sep. 18, 2000. The present invention does not, however, need to be implemented as part of a DPF as should be readily apparent to those skilled in the relevant art(s).

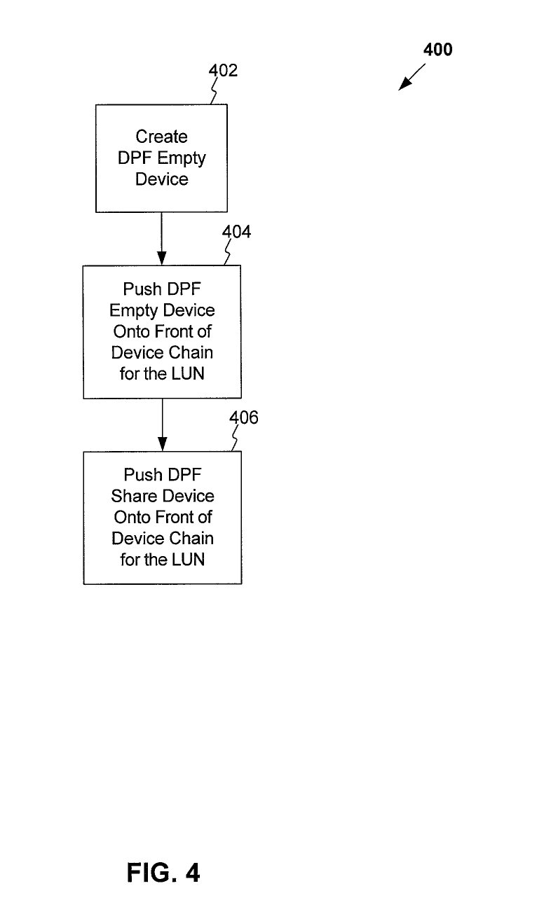

In order to implement a share device, such as share devices 202,304A and 304B, a logical unit number (LUN) must be transformed into a DPF share device module. FIG. 4 is a flow diagram for transforming a LUN into a DPF share device module. The process begins with step 402, where a DPF empty device module is created. The DPF empty device module is used as a placeholder to forward Small Computer Systems Interface (SCSI) requests upon completion of any applicable share device processing. The creation of a placeholder eliminates the need to look up the next device in the device chain for each SCSI request that is processed.

In step 404, the DPF empty device module is pushed onto the front of the existing device chain for the LUN.

In step 406, a DPF share device module is pushed onto the front of the existing device chain for the LUN. The purpose of the DPF share device module is to manage the space of a share device, such as share device 202, 304A, and 304B, and implement logical block mappings for each share target device using the physical storage device as its backing store. Mappings translate block numbers on the share target device to block numbers on the physical storage device.

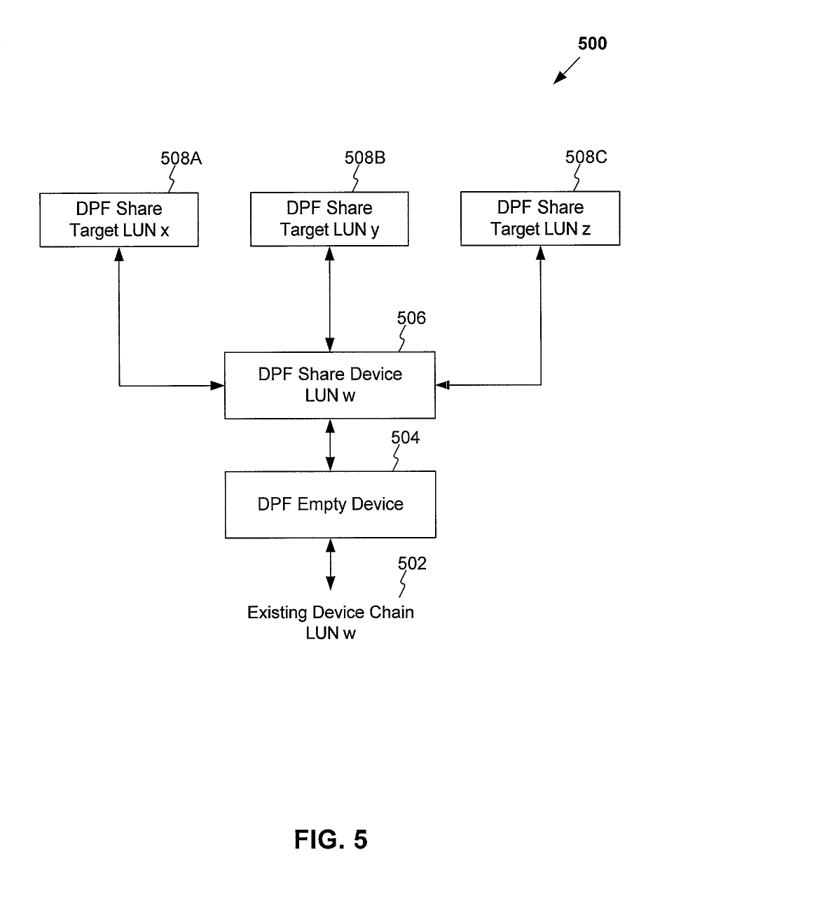

The LUN has now been transformed into a share device via the DPF share device module. FIG. 5 is a block diagram 500 representing the implementation of a DPF share device module. Diagram 500 comprises an existing device chain (LUN w) 502, a DPF empty device module 504, a DPF share device module 506, and a plurality of DPF share target device modules 508A-C. As shown in FIG. 5, DPF empty device module 504 is pushed onto existing device chain 502. DPF share device module 506 is then pushed onto DPF empty device module 504. DPF share device module 506 is assigned the same LUN as the existing device chain 502, that is, LUN w.

Once a LUN, such as LUN w, is made into a share device, the LUN cannot be used directly to make I/O requests with host computers. A share target must be used. DPF share target device modules 508A-C are configured and pushed onto DPF share device module 506. Each configuration of share target device modules 508A-C creates a new device chain that flows from each DPF share target device module 508A-C down to existing device chain 502. Each DPF share target device module 508A-C is provided a unique LUN, as shown in FIG. 5 (LUN x for DPF share target 508A, LUN y for DPF share target 508B, and LUN z for DPF share target 508C). Each DPF share target device module 508A-C registers itself with DPF share device module 506. During this registration process, each DPF share target device module is passed back a unique share ID that is used to identify the share target to the share device for future SCSI I/O requests.

Share Device Design

A share device is basically a rudimentary file system. A device underlying the share device, such as disk array 106, virtual device 302, or physical storage disk 310, is broken up into logical blocks of disk sectors. In one embodiment, the default size for a logical block is 8K bytes.

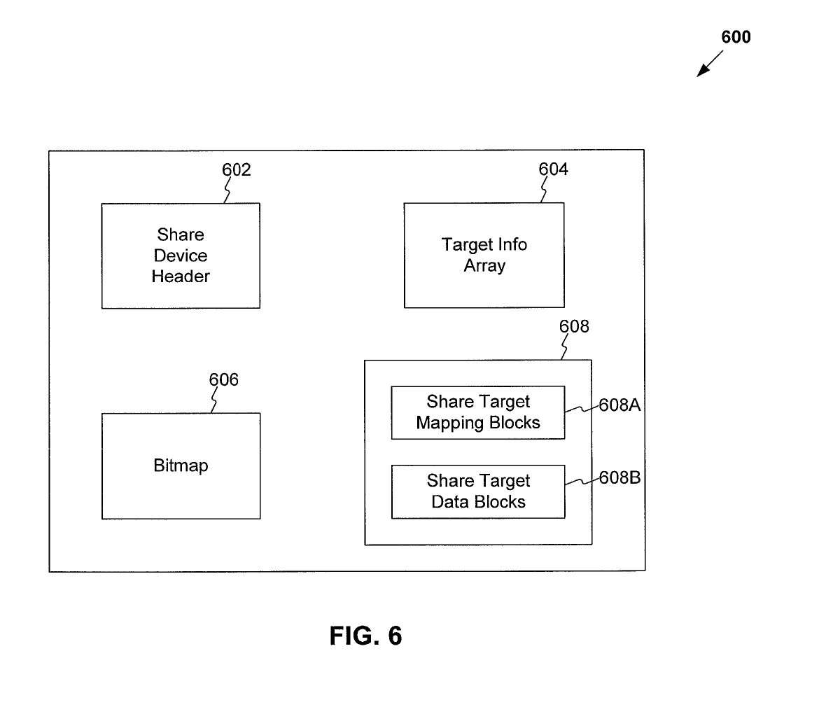

FIG. 6 is an exemplary diagram of the components of a share device 600. Share device 600 is comprised of four main components: a share device header 602, a target information array 604, a bitmap 606, and either share target mapping blocks 608 or share target data blocks 610.

In embodiments, share device header 602 is usually found in Block 0 of share device 600. Share device header 602 serves as the table of contents to the rest of share device 600. Share device header 602 contains information that allows share device 600 to manage and locate other data structures on share device 600.

Target information array 604 is comprised of entries that contain information about each individual share target that share device 600 manages. In one embodiment, target information array 604 has a fixed size of 128 entries. One skilled in the relevant art(s) would know that more or less entries could be used without departing from the scope of the present invention.

Bitmap 606 keeps track of whether blocks within share device 600 are allocated or not. If a bit is one (1), then the corresponding block is allocated. A bit value of zero (0) indicates that the corresponding block is free. The bits for all share device 600 blocks that contain share device data structures are set to 1 at initialization time. Bitmap 606 is relocatable, that is, it can be moved to different blocks within share device 600 to allow for future expansion of bitmap 606. In one embodiment, two fields, bitmapFirstSector and bitmapBytes, in share device header 602 indicate the start and length, respectively, of bitmap 606.

Bitmap 606 is used to manage space on share device 600. Bitmaps are an efficient mechanism, in terms of memory and disk space required, to manage a large number of share device blocks. Ordinarily, it would be inefficient to scan a bitmap for free space if free space in the bitmap becomes fragmented. With the present invention, fragmentation is reduced because space is not typically released on a block level. Instead, the present invention releases space when an entire share target is unconfigured or removed. This results in large amounts of space being released at one time.

When bitmap 606 is initialized, it is passed information indicating whether it should create a new bitmap or reload a pre-existing bitmap (stored on a physical storage device). Bitmap 606 maintains a header. If bitmap 600 is to be preserved across reboots to the system, a caller, such as the share device or the share target, must supply a physical storage device and region on that physical storage device to store the bitmap header and bitmap 606. By allowing the caller to specify the location of bitmap 606 on the device, the caller is allowed to relocate bitmap 606 when offline. In one embodiment, bitmap 606 is stored directly on the physical storage device of which the share device is connected. In another embodiment, bitmap 606 is stored on a dedicated disk device along with other configuration data. Alternatively, bitmap 606 could reside on SAN appliance 104.

Each bitmap 606 has a lock to coordinate access to it. Manipulation of bitmap 606 would be readily apparent to persons skilled in the relevant art(s).

The remaining blocks 608 in share device 600 are either share target mapping blocks 608A or share target data blocks 608B.

Block Mappings

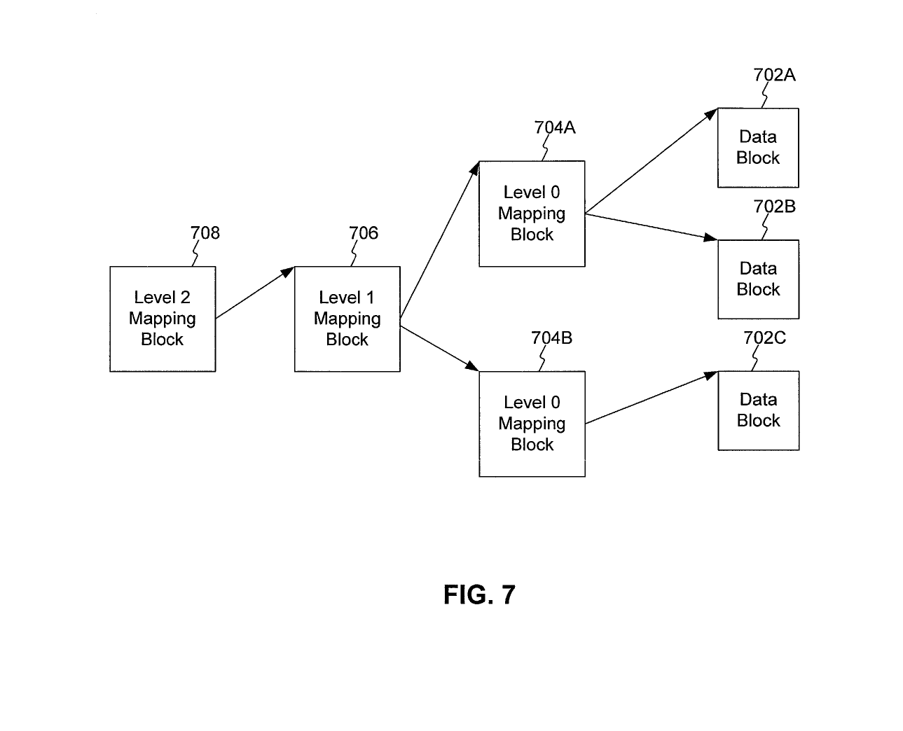

Each share target device has associated with it a set of block mappings. These mappings are implemented using a well known common technique used for files in file systems. FIG. 7 is a block diagram indicating mapping block levels according to an embodiment of the present invention. The smallest mapping unit is a single 4 byte data block mapping 702A-C. This mapping contains the physical storage device block number assigned to a particular share target logical block. The block represented by this block number contains the actual data of the share target logical block.

The next level of mapping units is a level 0 mapping block 704A and 704B. Level 0 mapping blocks 704A and 704B contain data block mappings. In an embodiment, the size of a physical storage device block is a power of two and the size of a single mapping is a power of two, thus, an even number of mappings will fit in a physical storage device block. As previously stated, the default logical share device block is 8K bytes, so a single level 0 mapping block (704A or 704B) can hold 2048 data block mappings.

The next level of mapping is a level 1 mapping block 706. Level 1 mapping block 706 contains physical device block numbers of level 0 mapping blocks for the share target. Similar to level 0 mapping blocks 704A and 704B, given an 8K bytes share device block, level 1 mapping blocks 706 can hold 2048 level 0 mappings.

The next level of mapping is a level 2 mapping block 708. Level 2 mapping blocks 708 contain mappings for level 1 mapping blocks 706. Level 2 mapping block 708 is the highest mapping level needed because 3 mapping levels are sufficient to map 32 bit block numbers. A share target's mapping does not necessarily contain all three levels. The number of levels created is the minimum number of levels necessary to map the share target data block with the highest block number that has a mapping. Each entry in target information array 604 contains two values: (1) mapBlk, which is the block number of the highest level mapping block; and (2) levels, which is the current number of mapping levels of the share target's mappings.

In an embodiment, it is possible to have multiple threads accessing a share target's mappings simultaneously. Mapping integrity is maintained by holding locks on the mapping blocks. As shown in FIG. 7, the mappings form a tree structure. The top of the mapping tree is protected by a separate semaphore, mapSema[ ], in the DPF share device module 506. This semaphore is held while the mapBlk and levels values are being examined and while the number of mapping levels for a share target is being modified.

While traversing the tree, a lock will be taken on the current mapping block being examined. When the next block number needed to continue traversing the tree is retrieved, the lock can be released. There is no need to continue holding the lock as the tree is traversed because under normal circumstances, mappings are always added, not deleted. The only cases where mappings are deleted is when a share target is being deleted or resized smaller. In these cases, a top level semaphore, mapSema[ ], on the mappings is held.

In the case of a write operation, a mapping entry that is NULL may be encountered. In this case, a new data block needs to be allocated and the necessary mapping blocks need to be setup. While this process is taking place, the lock on the mapping block with the NULL entry is held to ensure that no other thread tries to create the same mapping. Once the mapping is in place, the lock can be released.

Buffer Cache Design

SAN appliance 104 contains a buffer cache. The buffer cache contains buffers. The buffers contain recently accessed data (e.g., mappings, etc.) from physical storage. In one embodiment, the default buffer size is 8K bytes. Each buffer has a DPF buffer header. The buffer header maintains information about the state of the buffer. For example, in one embodiment, the buffer header contains the address of the buffer, information about whether the buffer is currently locked by a thread, the disk blocks that are currently cached in the buffer, whether the buffer contains valid data, and the relative age of the buffer compared to other buffers in the buffer cache.

Caching includes the ability to locate and retrieve a buffer that already contains the requested data. The present invention includes caching for share target mapping blocks 608A because the mappings could potentially become too large to be kept in memory all at once, and it would be too expensive to go to disk each time a mapping is required.

Table 3 lists three interfaces that are available to retrieve buffers from a buffer cache. Each of these interfaces returns a buffer header with its corresponding buffer locked.

TABLE 3

| | |
|---|---|
| getEmptyBuffer() | Retrieves a scratch buffer which does not contain |
| | any useful data. |
| getBuffer() | Retrieves a buffer for particular sectors on a |
| | specified LUN. It also returns an indication of |
| | whether the buffer contains the LUN data or is |
| | uninitialized. It will not read the disk data to |
| | initialize the buffer. This is a useful interface if |
| | the caller is going to initialize the buffer |
| | themselves and write the buffer later. By |
| | creating the buffer and registering it in the buffer |
| | cache, it prevents other threads from accessing |
| | the same sector. |
| readBuffer() | Operates like the getBuffer() interface, except |
| | that readBuffer() will read the disk data to |
| | initialize the buffer before it returns. |

Table 4 lists two interfaces that are available for releasing buffers so that they can be accessed by other threads.

TABLE 4

| | |
|---|---|
| writeBuffer() | Writes the specified buffer out to disk before |
| | releasing the buffer. |
| releaseBuffer() | Releases the buffer without writing it back to disk. |

Buffer headers are kept on two lists: a hash list and a LRU list. The hash list helps to locate a particular buffer for a specified LUN and particular sectors on that LUN. Hash lists are well known to those skilled in the relevant art(s).

The LRU list determines the order in which buffers get reused. If a buffer does not contain valid data, it is placed on the front of the LRU list and is used first. Each time a buffer that contains valid data is used and released, it is moved to the end of the LRU list and will not be used until all of the buffers in front of it on the list have been used. Buffers that do not contain valid data are only on the LRU list and not the hash list. This avoids having to examine invalid buffers while searching hash lists.

Locking is required to maintain proper access to the buffers while being efficient and avoiding deadlock. There is a lock within the buffer header to synchronize access to the buffer, a lock for each hash list, and a lock for the LRU list to maintain consistency of the lists.

Write/Read Operations

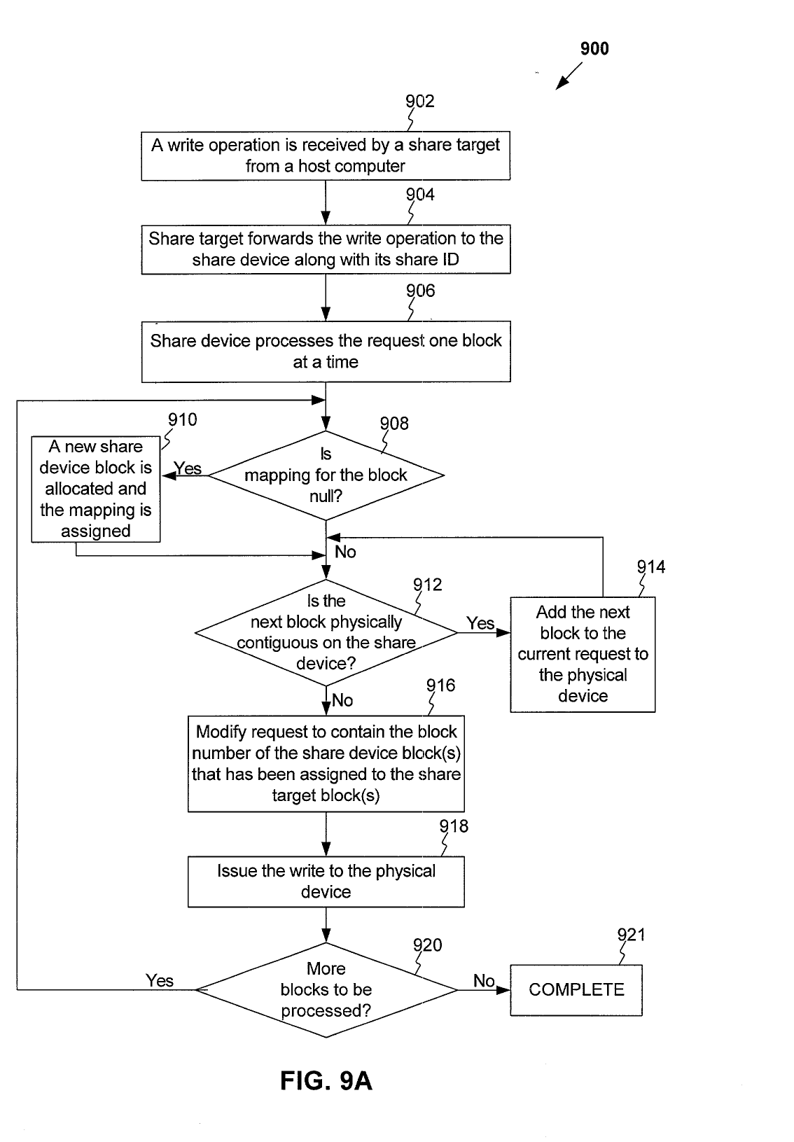

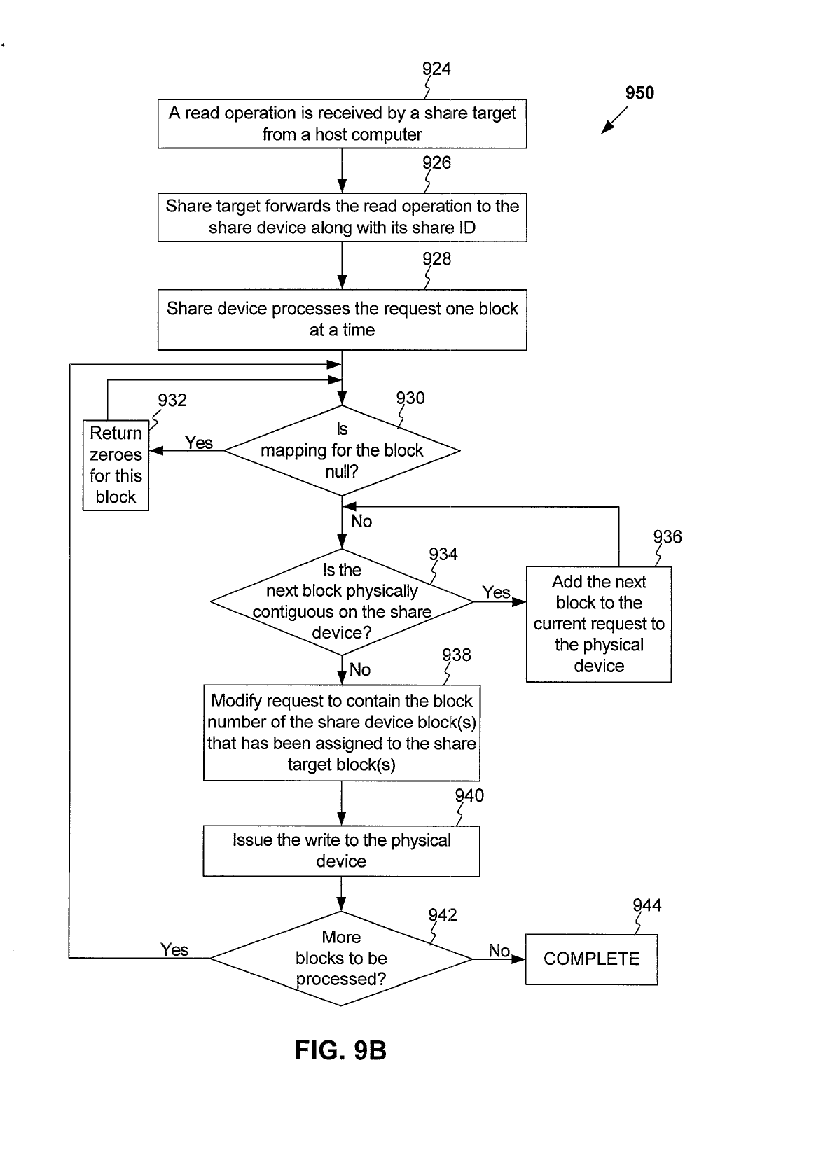

Write and read operations will now be described with respect to FIGS. 5, 9A and 9B.

FIG. 9A is a flow diagram 900 of a write operation according to an embodiment of the present invention. The process begins with step 902, where a write operation is addressed to a virtual LUN. That virtual LUN maps to a DPF share target device module, such as DPF share target device module 508A.

In step 904, DPF share target device module 508A forwards the write operation to DPF share device module 506. DPF share target device module 508A also sends a share ID along with the write operation to identify DPF share target device module 508A as the DPF share target device module making the request.

In step 906, DPF share device module 506 processes the request one block at a time. The process then proceeds to decision step 908.

In decision step 908, it is determined if the mapping for a block is NULL. If the mapping for a block is NULL, a new share device block is allocated and mapping is assigned in step 910. The process then proceeds to step 912.

Returning to decision step 908, if it is determined that the mapping for a block is not NULL, the process proceeds to step 912.

In decision step 912, if it is determined that the next block in the request is physically contiguous on the share device, then the next block is added to the current request to the physical device in step 914. The process steps of 912 and 914 are repeated until all the blocks in the request are processed, or a non-contiguous block is found. If either of those conditions are satified, the process continues to step 916.

In step 916, the request is modified to contain the block number of the share device block(s) that has been assigned to the share target block(s). The process proceeds to 918.

In step 918, the write is issued to the physical device.

In decision step 920, it is determined whether there are any additional blocks to be processed. Process flow continues back to decision step 908 if there are additional blocks to be processed. Otherwise, the share device processing is complete in step 921.

FIG. 9B is a flow diagram 950 of a read operation according to an embodiment of the present invention. The process begins with step 924, where a read operation is addressed to a virtual LUN. That virtual LUN maps to a DPF share target device module, such as DPF share target device module 508A.

In step 926, DPF share target device module 508A forwards the read operation to DPF share device module 506. DPF share target device module 508A also sends a share ID along with the read operation to identify DPF share target device module 508A as the DPF share target device module making the request.

In step 928, DPF share device module 506 processes the request one block at a time. The process then proceeds to decision step 930.

In decision step 930, it is determined if the mapping for a block is NULL. If the mapping for a block is NULL, in step 932 all zeroes (0s) are returned for the block and control is returned to decision step 930 or the next block in the request.

Returning to decision step 930, if it is determined that the mapping for a block is not NULL, the process proceeds to decision step 934.

In decision step 934, if it is determined that the next block in the request is physically contiguous on the share device, then the next block is added to the current request to the physical device in step 936. The process steps of 934 and 936 are repeated until all the blocks in the request are processed, or a non-contiguous block is found. If either of those conditions are satified, the process continues to step 938.

In step 938, the request is modified to contain the block number of the share device block(s) that has been assigned to the share target block(s). The process proceeds to 940.

In step 940, the read is issued to the physical device.

In decision step 942, it is determined whether there are any additional blocks to be processed. Process flow continues back to decision step 930 if there are additional blocks to be processed. Otherwise, the share device processing is complete in step 944.

Share Device Command Line Interfaces

Table 5 lists all of the commands which apply to a share device.

TABLE 5

| | |
|---|---|
| makeShareDevice <LUN> | Initializes <LUN> as a |
| | share device so that it |
| | can be used to create |
| | share target virtual |
| | devices. <LUN> can |
| | either be a virtual or a |
| | physical <LUN>. |
| makeShareTarget <share device LUN> | Creates a share target |
| | virtual device with a new |
| | LUN number. |
| resizeShareTarget <share target LUN> <size> | Change the size of a |
| | share target device. |
| | <size> is in 512 byte |
| | block units. Note that the |
| | size of share target LUN |
| | cannot be modified while |
| | the LUN is mapped to a |
| | host. |
| resetShareTarget <share target LUN> | Reinitialize the share |
| | target device. All of the |
| | space which is currently |
| | being used by the share |
| | target is released and |
| | returned to the share |
| | device for reuse. |
| unmakeShareTarget <share target LUN> | Unallocate a share target |
| | device. All resources |
| | reserved by the share |
| | target are released and |
| | returned to the share |
| | device for reuse. |
| unmakeShareDevice <share device LUN> | Returns a LUN to the |
| | state it was in before it |
| | became a share device. |

When a host system is connected to the virtual storage system, an administrator configures the share device and the associated share targets for the host system. For example, if the physical storage device is a 10 Gigabytes storage device, the administrator may create a share device that utilizes the entire 10 Gigabytes of storage space. The administrator may then create a share target from that share device that has any desired amount of virtual storage space. When the host system looks for disks, it will see the share target with the desired amount. A sample procedure of how commands from Table 5 can be used together to make a snapshot to a device smaller than the original LUN is provided in Table 6.

TABLE 6

| | Explanation |
|---|---|
| Sample Procedure | of the Code |
| 1. makeShareDevice <share device LUN> | Initializes <share |
| | device LUN> as a |
| | share device. |
| 2. makeShareTarget <share device LUN> | Creates a new LUN |
| | number that will be |
| | used as the snapshot |
| | target device. |
| 3. resizeShareTarget <share target LUN> <size> | Makes <share target |
| | LUN> the appropriate |
| | size for the snapshot. |

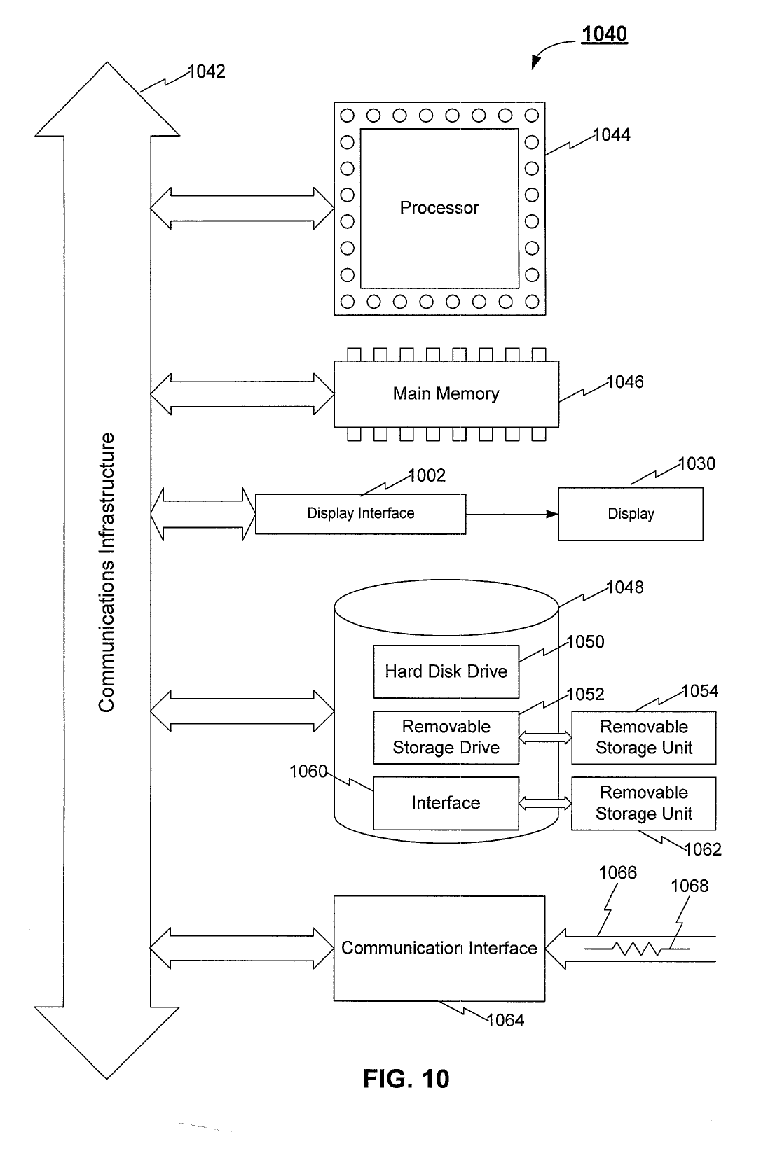

An example of a computer system 1040 is shown in FIG. 10. The computer system 1040 represents any single or multi-processor computer. In conjunction, single-threaded and multi-threaded applications can be used. Unified or distributed storage systems can be used. Computer system 1040, or portions thereof, may be used to implement the present invention. For example, the share device modules and share target modules of the present invention may comprise software running on a computer system, such as computer system 1040.

In one example, the virtual storage system of the present invention, including device chain 502, may be implemented using a high-level programming language (e.g., C++) and applications written for the Microsoft Windows™ environment. It will be apparent to persons skilled in the relevant art(s) how to implement the invention in alternative embodiments from the teachings herein.

Computer system 1040 includes one or more processors, such as processor 1044. One or more processors 1044 can execute software implementing routines described above, such as shown in Table 6. Each processor 1044 is connected to a communication infrastructure 1042 (e.g., a communications bus, cross-bar, or network). Various software embodiments are described in terms of this exemplary computer system. After reading this description, it will become apparent to a person skilled in the relevant art how to implement the invention using other computer systems and/or computer architectures.

Computer system 1040 can include a display interface 1002 that forwards graphics, text, and other data from the communication infrastructure 1042 (or from a frame buffer not shown) for display on the display unit 1030.

Computer system 1040 also includes a main memory 1046, preferably random access memory (RAM), and can also include a secondary storage 1048. The secondary storage 1048 can include, for example, a hard disk drive 1050 and/or a removable storage drive 1052, representing a floppy disk drive, a magnetic tape drive, an optical disk drive, etc. The removable storage drive 1052 reads from and/or writes to a removable storage unit 1054 in a well known manner. Removable storage unit 1054 represents a floppy disk, magnetic tape, optical disk, etc., which is read by and written to by removable storage drive 1052. As will be appreciated, the removable storage unit 1054 includes a computer usable storage medium having stored therein computer software and/or data.

In alternative embodiments, secondary storage 1048 may include other similar means for allowing computer programs or other instructions to be loaded into computer system 1040. Such means can include, for example, a removable storage unit 1062 and an interface 1060. Examples can include a program cartridge and cartridge interface (such as that found in video game devices), a removable memory chip (such as an EPROM, or PROM) and associated socket, and other removable storage units 1062 and interfaces 1060 which allow software and data to be transferred from the removable storage unit 1062 to computer system 1040.

Computer system 1040 can also include a communications interface 1064. Communications interface 1064 allows software and data to be transferred between computer system 1040 and external devices via communications path 1066. Examples of communications interface 1064 can include a modem, a network interface (such as Ethernet card), a communications port, interfaces described above, etc. Software and data transferred via communications interface 1064 are in the form of signals which can be electronic, electromagnetic, optical or other signals capable of being received by communications interface 1064, via communications path 1066. Note that communications interface 1064 provides a means by which computer system 1040 can interface to a network such as the Internet.

The present invention can be implemented using software running (that is, executing) in an environment similar to that described above. In this document, the term “computer program product” is used to generally refer to removable storage unit 1054, a hard disk installed in hard disk drive 1050, or a carrier wave carrying software over a communication path 1066 (wireless link or cable) to communication interface 1064. A computer useable medium can include magnetic media, optical media, or other recordable media, or media that transmits a carrier wave or other signal. These computer program products are means for providing software to computer system 1040.

Computer programs (also called computer control logic) are stored in main memory 1046 and/or secondary storage 1048. Computer programs can also be received via communications interface 1064. Such computer programs, when executed, enable the computer system 1040 to perform the features of the present invention as discussed herein. In particular, the computer programs, when executed, enable the processor 1044 to perform features of the present invention. Accordingly, such computer programs represent controllers of the computer system 1040.

The present invention can be implemented as control logic in software, firmware, hardware or any combination thereof. In an embodiment where the invention is implemented using software, the software may be stored in a computer program product and loaded into computer system 1040 using removable storage drive 1052, hard disk drive 1050, or interface 1060. Alternatively, the computer program product may be downloaded to computer system 1040 over communications path 1066. The control logic (software), when executed by the one or more processors 1044, causes the processor(s) 1044 to perform functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s) from the teachings herein.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A virtual storage system for providing efficient use of storage resources, comprising:
a plurality of host systems;
an appliance coupled to each of said plurality of host systems; and
at least one physical storage device coupled to said appliance;
wherein said appliance manages the allocation of physical storage space on said at least one physical storage device to said plurality of host systems, and manages the allocation of virtual storage space to said plurality of host systems, wherein the cumulative amount of virtual storage space allocated to said plurality of host systems exceeds the actual storage capacity of said at least one physical storage device.

2. The system of claim 1, wherein said appliance comprises:
at least one share device coupled to said at least one physical storage device, said at least one share device being a gateway to said at least one physical storage device; and
one or more share targets, wherein each of said plurality of host systems is coupled to one or more of said share targets, wherein said one or more share targets are created by and coupled to said at least one share device.

3. The system of claim 2, wherein said share device comprises:
a share device header for providing information allowing said share device to manage and locate other data structures on said share device;
a bitmap for keeping track of whether blocks within said share device are allocated;
a target information array for containing information about each of said one or more share targets that said share device manages; and
share target mapping blocks containing virtual to physical mappings for said one or more share targets.

4. The system of claim 3, wherein said bitmap is temporarily stored in a cache on said appliance.

5. The system of claim 2, wherein said at least one physical storage device serves as a backing store for said one or more share targets.

6. The system of claim 2, wherein one of said host systems is coupled to more than one share target.

7. The system of claim 2, wherein more than one of said host systems is coupled to one share target.

8. The system of claim 2, wherein said one or more share targets and said share device are assigned unique logical unit numbers.

9. The system of claim 1, wherein physical space is allocated to said host systems as blocks on said at least one physical storage device are written.

10. The system of claim 1, wherein said appliance is a storage area network (SAN) appliance.

11. The system of claim 1, wherein virtual disk devices are allocated to said plurality of host systems, and wherein said plurality of host systems utilize said virtual disk devices in a manner similar to the usage of a physical disk device.

12. The system of claim 1, wherein said at least one physical storage device serves as a backing store for said virtual storage system.

13. The system of claim 1, wherein each of said plurality of host systems are allocated physical storage space on a first come, first serve basis.

14. The system of claim 1, wherein each of said plurality of host systems are given a priority rating, and are allocated physical storage space based on said priority rating.

15. A virtual storage system, comprising:
a plurality of host computers;
a storage area network (SAN) appliance coupled to each of said plurality of host computers; and
a storage area network (SAN) having a plurality of physical storage devices, said SAN coupled to said SAN appliance,
wherein said SAN appliance manages the allocation of physical storage space on said SAN to said plurality ofhost computers, and manages the allocation of virtual storage space to said plurality of host computers, wherein the cumulative amount of virtual storage space allocated to said plurality of host computers exceeds the actual storage capacity of said plurality of physical storage devices in said SAN.

16. The system of claim 15, wherein said SAN appliance comprises:
a plurality of share devices coupled to said plurality of physical storage devices in said SAN, wherein each of said share devices is connected to a different one of said physical storage devices, each of said share devices being a gateway to said physical storage device of which it is connected; and
a plurality of share targets coupled to each of said plurality of host computers, wherein said plurality of share targets are created by and coupled to at least one of said share devices as virtual disk devices.

17. The system of claim 15, wherein said SAN appliance comprises:
a plurality of share devices coupled to said plurality of physical storage devices in said SAN, wherein two or more of said share devices are coupled to any one of said plurality of physical storage devices in said SAN, wherein said physical storage device connected to said two or more share devices is partitioned according to the number of share devices in which it connects; and
a plurality of share targets coupled to each of said plurality of host computers, wherein said plurality of share targets are created by and coupled to at least one of said share devices as virtual disk devices.

18. A method for providing efficient use of storage resources, comprising the steps of:
(1) configuring a virtual management device for managing and allocating physical storage space to a plurality of host computers;
(2) configuring a virtual disk device from the virtual management device for each of the plurality of host computers; and
(3) allocating virtual space to each of the plurality of host computers, wherein the cumulative storage capacity for the virtual disk devices exceeds the amount of physical storage space available.

19. The method of claim 18, further comprising the step of allocating physical space to each of the host computers on an as needed basis.

20. A method for providing virtual storage using a data propagation framework (DPF), comprising the steps of:
(1) generating a DPF empty device for a placeholder to forward Small Computer Systems Interface (SCSI) requests;
(2) placing the DPF empty device onto an existing device chain;
(3) generating a DPF share device module to manage a share device;
(4) placing the DPF share device module onto the existing device chain; and
(5) configuring one or more share target device modules as virtual disk devices for a plurality of host computers, wherein each share target device module provides a new device chain that flows from each share target device module down through the DPF empty device, and wherein I/O requests from a host computer are entered via the share target device module and travel down the device chain, wherein the I/O request is processed only by those modules that are designed to understand the I/O request.

21. The method of claim 20, wherein step (5) further comprises the step of allocating virtual disk space to each virtual disk device configured, wherein the cumulative storage capacity for the virtual disk devices exceeds the amount of physical storage space available.

22. The method of claim 20, further comprising the step of enabling the share device module to implement logical block mappings for each share target device module configured using a physical storage device that is coupled to the share target device module as a backing store.

23. The method of claim 20, further comprising the step of allocating physical storage space to each of the plurality of host computers on an as needed basis.

24. A computer program product comprising a computer useable including control logic stored therein, said control logic providing efficient use of storage resources for a virtual storage system, said control logic comprising:
first configuring means for enabling a processor to configure a virtual management device for managing and allocating physical storage space to a plurality of host computers;
second configuring means for enabling a processor to configure a virtual disk device from the virtual management device for each of the host computers; and
allocating means for enabling a processor to allocate virtual space to each of the plurality of host computers, wherein the cumulative storage capacity for the virtual disk devices exceeds the amount of physical storage space available.

25. The computer program product of claim 24, said control logic further comprising means for enabling a processor to allocate physical space to each of the host computers on an as needed basis.

26. A storage area network appliance, comprising:
at least one share device, said at least one share device being a gateway to at least one physical storage device; and
one or more share targets, wherein a plurality of host systems is coupled to said one or more of share targets, wherein said one or more share targets are created by and coupled to said at least one share device as virtual storage devices.

27. The storage area network appliance of claim 26, wherein said share device comprises:
a share device header for providing information allowing said share device to manage and locate other data structures on said share device;
a bitmap for keeping track of whether blocks within said share device are allocated;
a target information array for containing information about each of said one or more share targets that said share device manages; and
share target mapping blocks containing virtual to physical mappings for said one or more share targets.

28. The storage area network appliance of claim 26, wherein said storage area network appliance manages the allocation of physical storage space on said at least one physical storage device to said plurality of host systems, and manages the allocation of virtual storage space to said plurality of host systems, wherein the cumulative amount of virtual storage space allocated to said plurality of host systems exceeds the actual storage capacity of said at least one physical storage device.
